(19) United States
(12) Patent Application Publication
(10) Pub. No.: US 2018/0285914 A1
(43) Pub. Date: Oct. 4, 2018

(54) CUSTOMER LOYALTY, ARCHITECTURE, SYSTEM, AND METHOD

(71) Applicant: House Advantage, Las Vegas, NV (US)

(72) Inventor: Jon C. Wolfe, Las Vegas, NV (US)

(73) Assignee: House Advantage, Las Vegas, NV (US)

(21) Appl. No.: 15/945,729

(22) Filed: Apr. 4, 2018

Related U.S. Application Data
(60) Provisional application No. 62/481,122, filed on Apr. 4, 2017.

(51) Int. Cl. G06Q 30/02

(52) U.S. Cl. CPC G06Q 30/0227

(57) ABSTRACT

Embodiments of an architecture for customer service or goods providers that encourages customers to use their services and purchase their goods by providing rewards based on consumption, the rewards usable for their services or goods or for another provider of goods or services where the rewards may be monetary or credits usable for goods or service of the provider or another provider. Different providers may create relationships where their respective customers may accumulate and use rewards for their goods or services. Other embodiments may be described and claimed.

### CROSS REFERENCE TO RELATED APPLICATIONS

The present application is related to and claims priority to U.S. Provisional Application No. 62/481,122, entitled “Systems, Methods, Components, and Software for Casino Customer Loyalty”, filed Apr. 4, 2017, Attorney Docket Number 226.001PV1, which is incorporated by reference.

### TECHNICAL FIELD

Various embodiments described herein relate generally applications, apparatus, systems, and methods to reward customer activity at various institutions and locations.

### BACKGROUND INFORMATION

A customer service or goods provider may wish to encourage customers to use their services and purchase their goods. A customer service or goods provider may want to provide rewards usable for their services or goods or for another provider of goods or services where the rewards may be monetary or credits usable for goods or service of the provider or another provider. Different providers may create relationships where their respective customer may accumulate and use rewards for their goods or services. The present invention provides such interactions and reward architecture.

### BRIEF DESCRIPTION OF THE DRAWINGS

FIG. 1A is a block diagram of multiple platform goods and services providers customer loyalty (MP-GSP-CL) architecture according to various embodiments.

FIG. 1B is a block diagram of another multiple platform goods and services providers customer loyalty (MP-GSP-CL) architecture according to various embodiments.

FIG. 2A is a block diagram of communications between a customer or user system (CUS), goods or service provider (GSP)—3^{rd} party onsite system (GSP-OS) with loyalty system interface (LSI), customer loyalty system (CLS), and a GSP—3^{rd} party financial system (GSP-FS).

FIG. 2B is a block diagram of communications between a GSP-OS with loyalty system interface (LSI), a CLS, and a GSP-FS.

FIG. 2C is a block diagram of communications between a CLS controller system (CLS-CS) and a CLS.

FIG. 3A is a block diagram of MP-GSP-CL architecture providing a client page to a customer via a CUS according to various embodiments.

FIG. 3B is a block diagram of MP-GSP-CL architecture providing a client page to a customer via a GSP-OS loyalty system interface (LSI) according to various embodiments.

FIG. 3C is a block diagram of MP-GSP-CL architecture providing a CLS-CS main page to a user via a CLS-CS according to various embodiments.

FIG. 4A illustrates a CLS-CS main page (GUI) display for configuring inbound properties according to various embodiments.

FIG. 4B illustrates a CLS-CS main page (GUI) display for configuring outbound properties according to various embodiments.

FIG. 4C illustrates a CLS-CS main page (GUI) display for configuring exchange rates between subaccounts of a GSP or property according to various embodiments.

FIG. 4D illustrates a CLS-CS main page (GUI) display for adding an exchange rate for subaccount or buckets for multiple GSPs or properties according to various embodiments.

FIG. 4E illustrates a CLS-CS main page (GUI) display for creating blackout state for exchange rate between providers according to various embodiments.

FIG. 4F illustrates a CLS-CS main page (GUI) display for creating blackout state weekly settings for exchange rate between providers according to various embodiments.

FIG. 4G illustrates a CLS-CS main page (GUI) display for locations for providers participating in architecture according to various embodiments.

FIG. 4H illustrates a CLS-CS main page (GUI) display for adding a location for a provider participating in architecture according to various embodiments.

FIG. 4I illustrates a CLS-CS main page (GUI) display for setting groups of locations of providers participating in architecture according to various embodiments.

FIG. 4J illustrates a CLS-CS main page (GUI) display for creating a new group of locations of providers participating in architecture according to various embodiments.

FIG. 4K illustrates a CLS-CS main page (GUI) display for viewing logs of transfers for past month in architecture according to various embodiments.

FIG. 4L illustrates a CLS-CS main page (GUI) display for viewing logs of transfers for a custom date range in architecture according to various embodiments.

FIG. 4M illustrates a CLS-CS main page (GUI) display for viewing spend/earning logs for a custom date range in architecture according to various embodiments.

FIG. 4N illustrates a CLS-CS main page (GUI) display for viewing exchange logs for a custom date range in architecture according to various embodiments.

FIG. 5A illustrates a customer-player dashboard (GUI) display showing transfer details in architecture according to various embodiments.

FIG. 5B illustrates a customer-player dashboard (GUI) display showing earning/spending details in architecture according to various embodiments.

FIG. 5C illustrates a customer-player dashboard (GUI) display showing exchange rate details in architecture according to various embodiments.

FIG. 5D illustrates a customer Alert (GUI) display in architecture according to various embodiments.

FIG. 6 is a block diagram of an article according to various embodiments.

FIG. 7 is a block diagram of an article according to various embodiments.

### DETAILED DESCRIPTION

A customer goods and service provider (GSP) may want to encourage their customers to use their services and purchase their goods. In an embodiment a GSP may provide or grant monetary and non-monetary rewards to a customer based on consumption/activities. The granted rewards may be usable for a GSP services or goods or for another provider of goods or services. The rewards may be monetary or credits usable for goods or service of the provider or another provider. In an embodiment, different GSP may create relationships where their respective customers may accumulate and use rewards for their respective goods or services. GSP may set agreed upon exchange rates for points or rewards granted by each GSP, where they may be used, and when they may be used. A customer may employ an encoded card or module 20A-20D to accumulate and redeem rewards. In an embodiment, a customer may accumulate and redeem rewards via an application resident on a personal device including personal data assistant (PDA), mobile phone, tablet, or other portable computer (CUS 60A-F).

In an embodiment, a GSP may provide systems 50A-H with loyalty system interface (LSI) on their site that enable customers to accumulate or redeem rewards via their encoded card or module 20A-20D or personal device—CUS 60A-F. In an embodiment, a GSP may provide rewards to a customer based on their actual activity onsite or using a service or goods of the GSP. In an embodiment, a GSP onsite system (termed GSP-OS) with loyalty system interface (LSI) may grant or accumulate rewards, enable redemption of rewards, and may also enable a customer to manage their rewards and exchange or move rewards for use with different GSP. In an embodiment, a customer may be able to use the LSI to transfer funds to a GSP, from a GSP to a selected account, or to another GSP. In an embodiment, GSP-OS 50A-H may be A GSP service or goods system that includes the loyalty system interface (LSI), for example, the GSP-OS loyalty system interface (LSI) may be a sub-system of an electronic gaming system (the GSP-OS), where a customer may use the loyalty system interface (LSI) to process their rewards, transfer funds to other accounts and to/from the gaming system.

In an embodiment, the electronic gaming system may be electronic forms of table games such as electronic poker, baccarat, roulette, and former mechanic games such as slot machines. In addition, the GSP may offer many onsite services including dining, bars, race and sportsbook, table games, poker tables, slot machines, hotel, casino cage, online/mobile gaming, shopping, golf courses, spa, pool, and automated teller machines (ATMs). A customer via their encoded card or module 20A-20D or personal device—CUS 60A-F may be able to accumulate or redeem rewards at any of the services or locations where the GSP may include a GSP-OS with loyalty system interface (LSI) at one or more of the services or locations. As a function of the service, a loyalty system interface (LSI) may be part of a GSP-OS 50A-H or may be a separate system or module or embedded in another system (as part of an electronic games system's user interface in an embodiment). Each onsite system GSP-OS 50A-H with loyalty system interface (LSI) may include an interface wireless (near field communication (NFC), Bluetooth, infra-red, zigbee, or other protocol), magnetic (magnetic card reader), or physical connection that is securely coupable to a customer's encoded card or module (CUS) 20A-20D or personal device—CUS 60A-F.

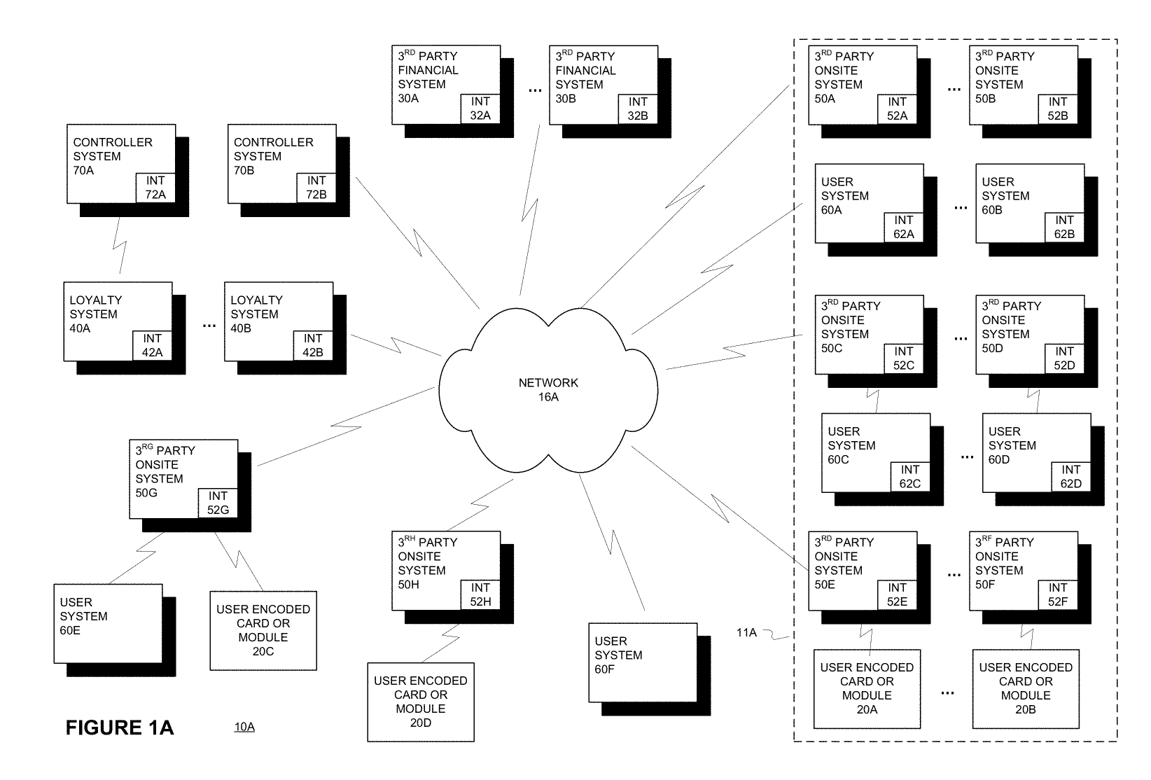

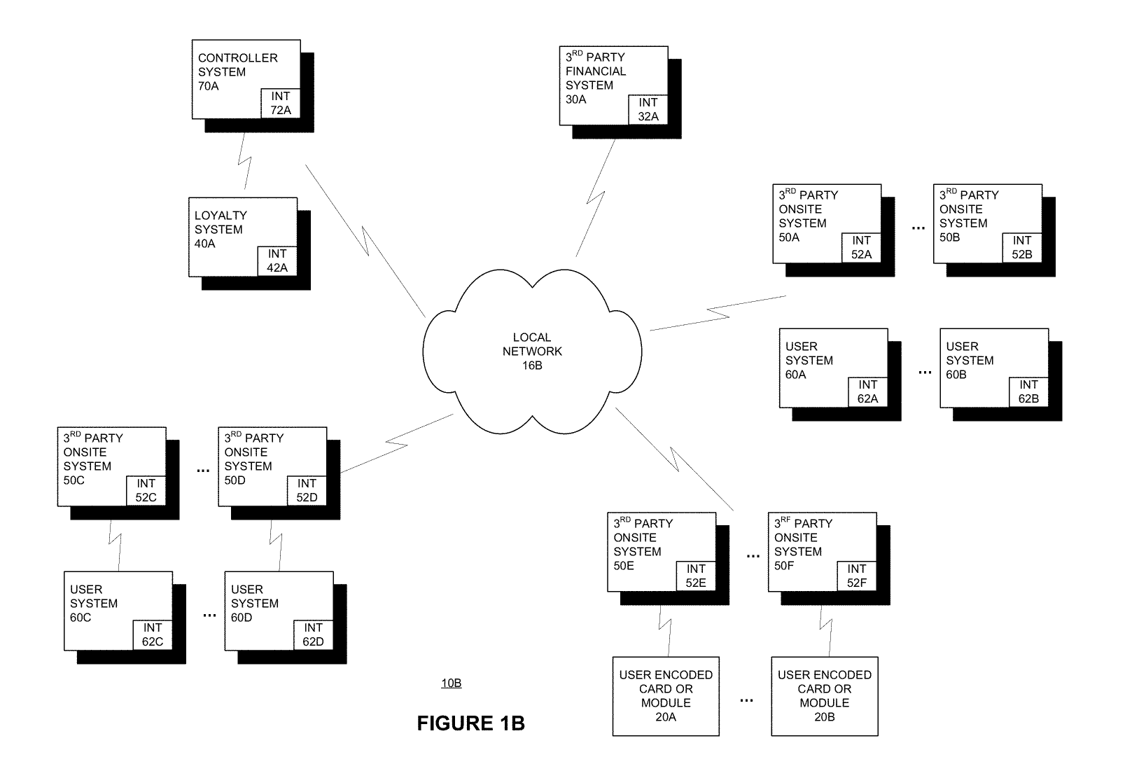

A GSP-OS 50A-H loyalty system interface (LSI) may process financial requests directly, via the underlying system (such as the gaming system), and via the CLS 40A-B and a separate financial system (GSP-FS) 30A-B, where the financial system GSP-FS 30A-B may be onsite or coupled to the CLS 40A-B via secure wired or wireless protocols. FIG. 1A is a block diagram of multiple platform goods and services providers customer loyalty (MP-GSP-CL) architecture 10A according to various embodiments. As shown in FIG. 1A, MP-GSP-CL architecture 10A includes network 16A, GSP-FS 30A-B, CLS 40A-B, GSP-OS 50A-H with LSI, CUS 60A-F, CLS-CS 70A-B, and user encoded card or module (UEC) 20A-D. The network 16A may represent a wired or wireless network that is local, remote, or a combination of both. For example, a GSP financial system (GSP-FS) 30A-B may be purposely located apart from their onsite systems 50A-H for security purposes or co-located for similar reasons or a combination of both.

MP-GSP-CL architecture 10A may include customer loyalty systems (CLS) 40A-B that are coupled to the GSP-OS 50A-H LSI to process rewards requests by customers including exchanges, money transfers, redemption, reports, and configuration. The CLS 40A-B may also be coupled to GSP-FS 30A-B where money transfer requests may be processed by GSP-FS 30A-B, controlled by a GSP or their representative. The CLS 40A-40B may also be coupled to one or more customer loyalty system controller systems (CLS-CS) 70A-B. A loyalty system administrator or user may be able to configure the operation of the loyalty systems 40A-B including exchange rates, properties, locations and customers able to use LSI via the CLS-CS 70A-B. In an embodiment, the GSP-OS (on site systems) LSI is coupled to the loyalty systems 40A-B—the LSI acting as an effective terminal only, reducing the load to the onsite systems 50A-H and enabling a simple interface to be embedded into existing systems of goods or service providers. Such a configuration enables a GSP to provide rewards service functionality to customers with little costs or modifications to their existing hardware or systems—50A-50H.

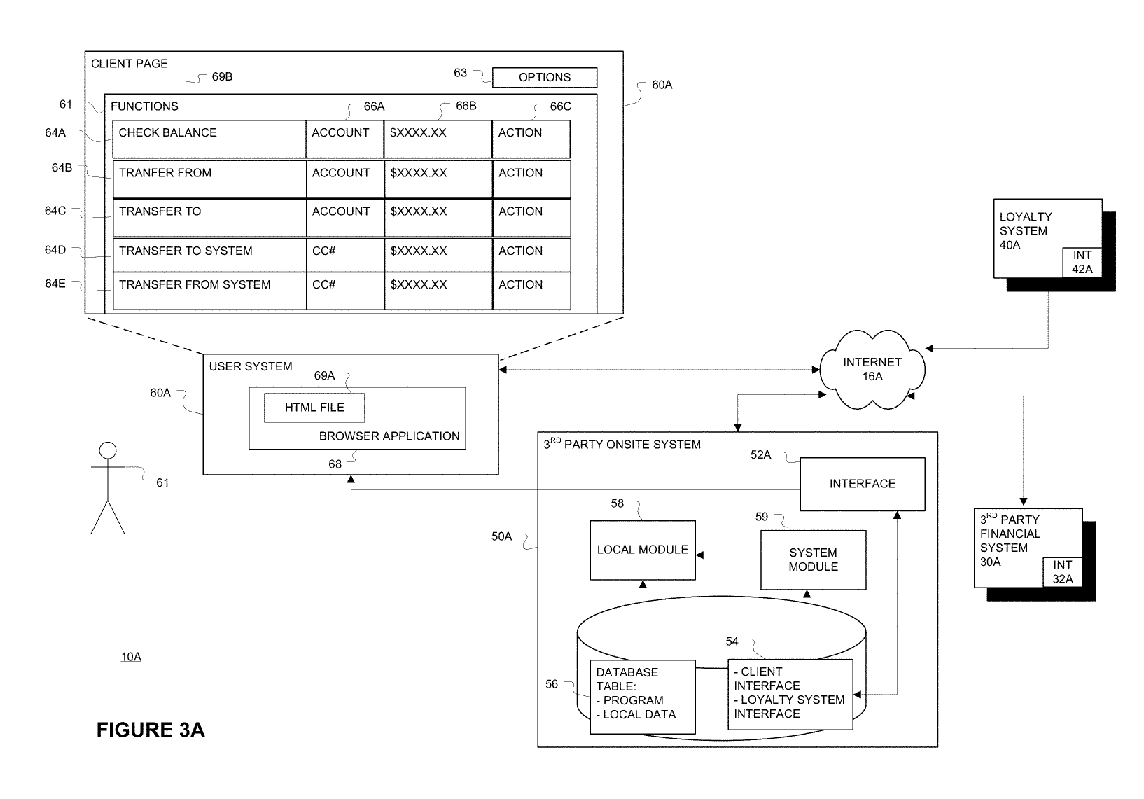

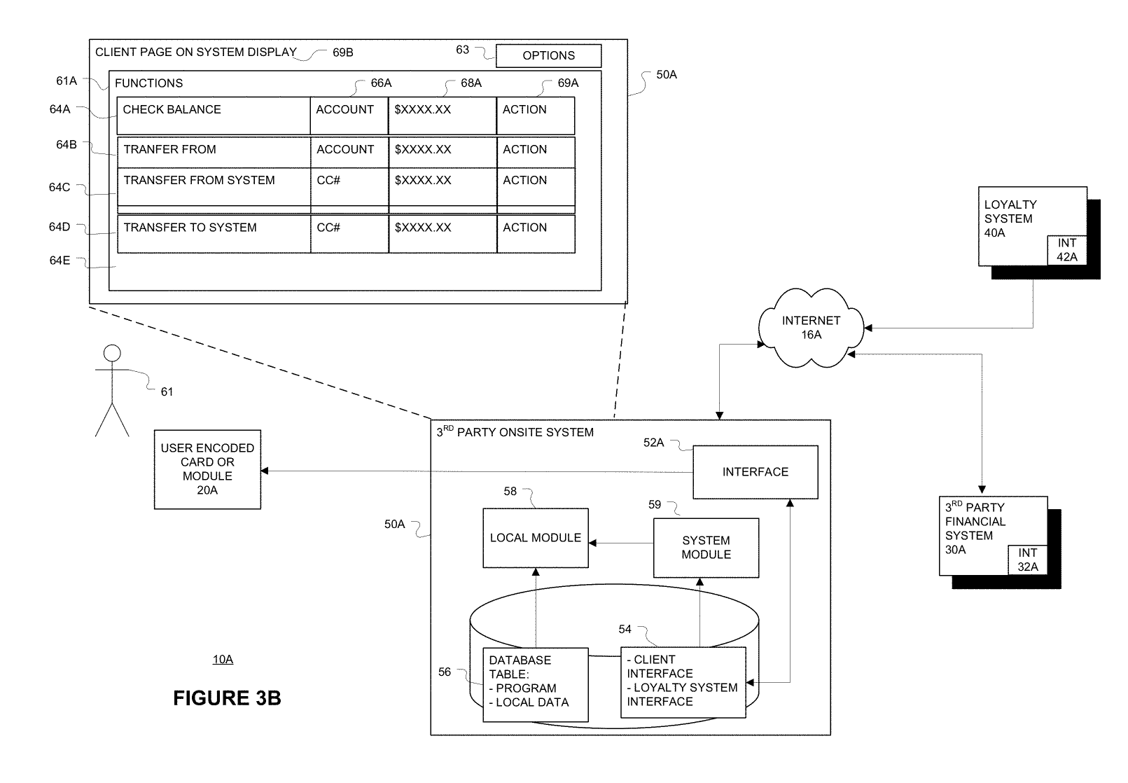

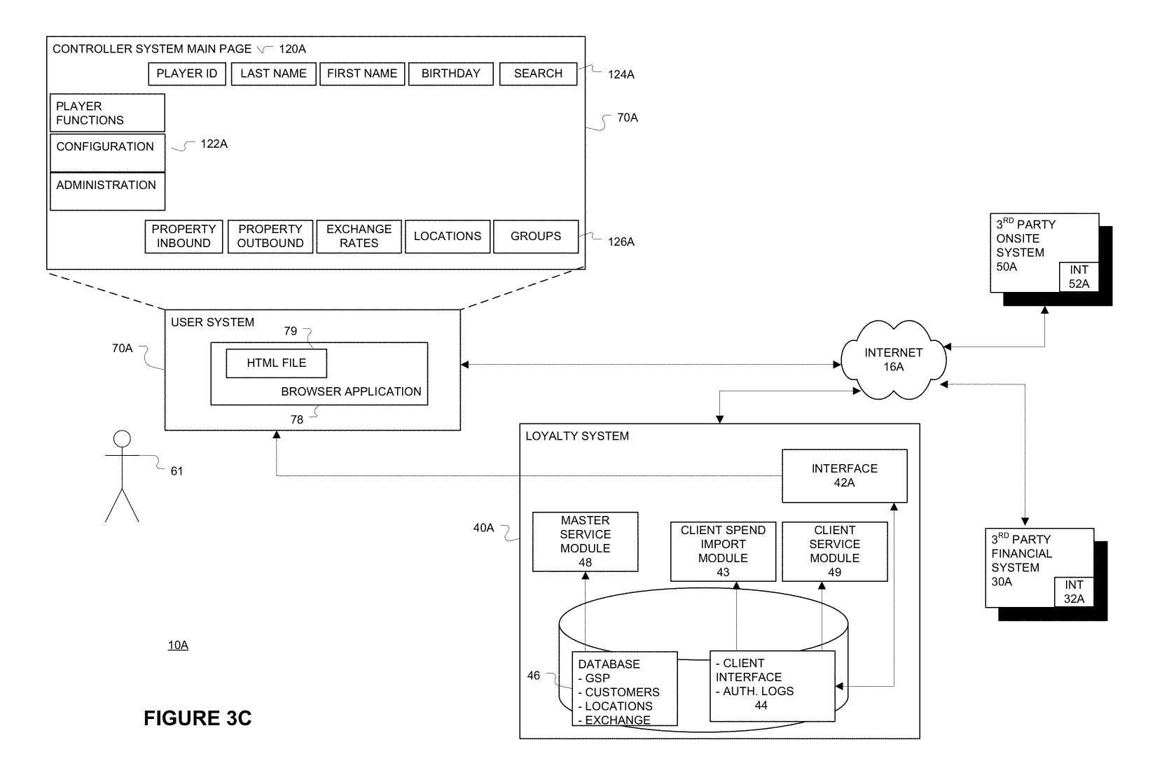

In an embodiment, a GSP-OS 50A-H may be an electronic gaming system with built in interface such a Aristocrat Sentinel, Bally SG iView, and IGT's Systems+. The CLS LSI may be integrated into such a system and may be Java, Adobe Flash, Brew, or other coding based application programming interface. The GSP-FS may be a Sightline system or communicate with a Sightline system or other GSP or gaming system provider payment system. The CLS 40A-B may include several modules including a client service module (49—FIG. 3C), a customer spend data import module (43—FIG. 3C), and a master service module (48—FIG. 3C). In an embodiment the master service module 48 may be embedded in the GSP FS 30A. In an embodiment, the client service module 49 may communicate between the LSI running on a GSP-OS 50A-H and the master service module 48.

The master service module 48 may communicate between the client service module 49 and a GSP-FS 30A-B (including Sightline and others) and store data in the database 46, which includes properties or participating goods and services providers, enrolled or authorized customer (or players), locations where GSP participate in the loyalty program, exchange database including exchange rate between subaccount and different GSPs in an embodiment. The client service module 49 and master service module 48 may employ secure protocols and programs including a secured representational state transfer (REST) application program interface (API). The client spend import module 43 may be securely coupable to a GSP-FS 30A-B to retrieve customer spending data including via a Sightline file transfer protocol (FTP).

As noted a goods or service provider GSP may include customer loyalty redemption interfaces (LSI) in their existing systems GSP-OS 50A-H that are located throughout their facility. For example, onsite systems 50A-F, CUS 60A-D, and UEC 20A-B may be within or communicating with a single facility 11A of a GSP. In an embodiment, the facility 11A may be casino or similar gaming facility and the onsite systems 50A-F may be or be part of a dining system, bar system, race and sportsbook system, table game systems, poker table systems, slot machines, hotel systems (in rooms), casino cage, online/mobile gaming, shopping, golf courses (on carts, pro shop), spa area, pool area, and automated teller machines (ATMs). As shown in FIG. 1A, other GSP-OS systems 50G, 50H including LSI may be located at other goods or services providers (GSP) locations, where the GSP are participants in the loyalty program/system such as non-gaming facilities or institutions such as independent food providers (Starbucks® and others). As also shown in FIG. 1A, a customer 61 via their CUS 60F via an application may be able to access the loyalty reward interface (shown in FIG. 3A) to communicate with a CLS 40A-B to review and maintain their rewards.

FIG. 1B is a block diagram of another multiple platform goods and services providers customer loyalty (MP-GSP-CL) architecture 10B according to various embodiments. As shown in FIG. 1B, MP-GSP-CL architecture 10B includes network 16B, GSP-FS 30A, CLS 40A, GSP-OS 50A-F, CUS 60A-D, CLS-CS 70A, and user encoded card or module (UEC) 20A-B. The network 16B may represent a wired or wireless network that is local, remote, or a combination of both. In an embodiment, for security purposes the GSP-FS 30A, CLS 40A, GSP-OS 50A-F, CUS 60A-D, CLS-CS 70A may be co-located.

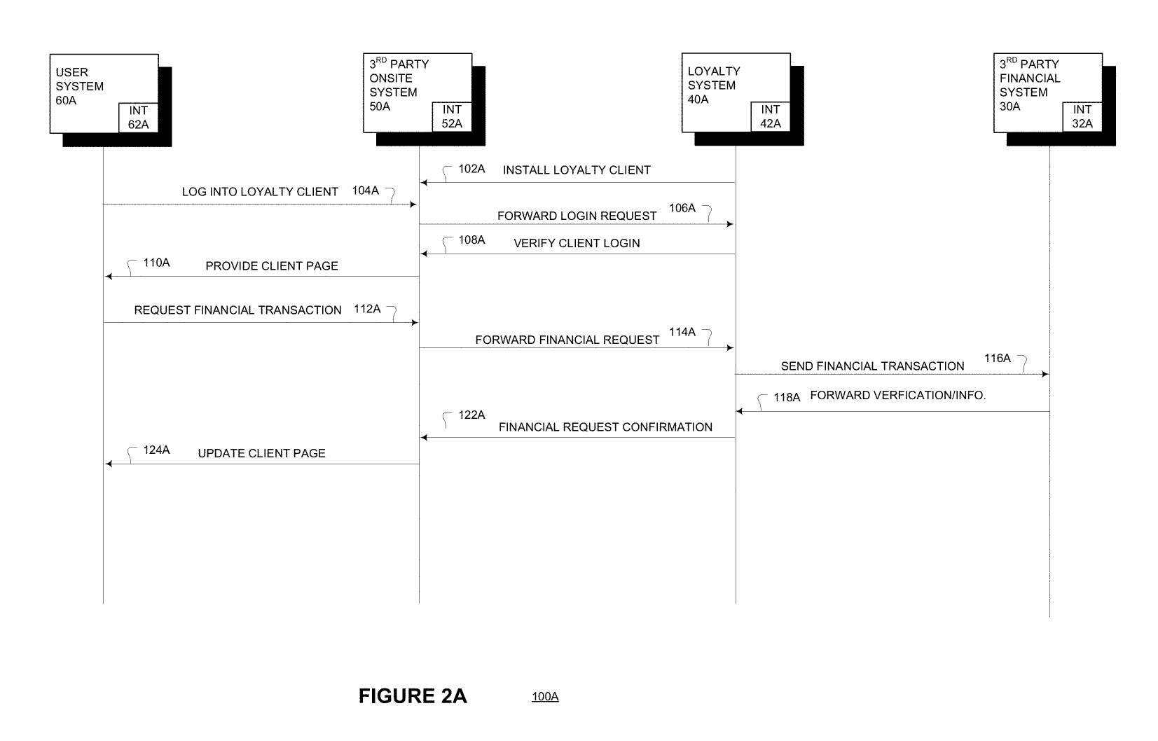

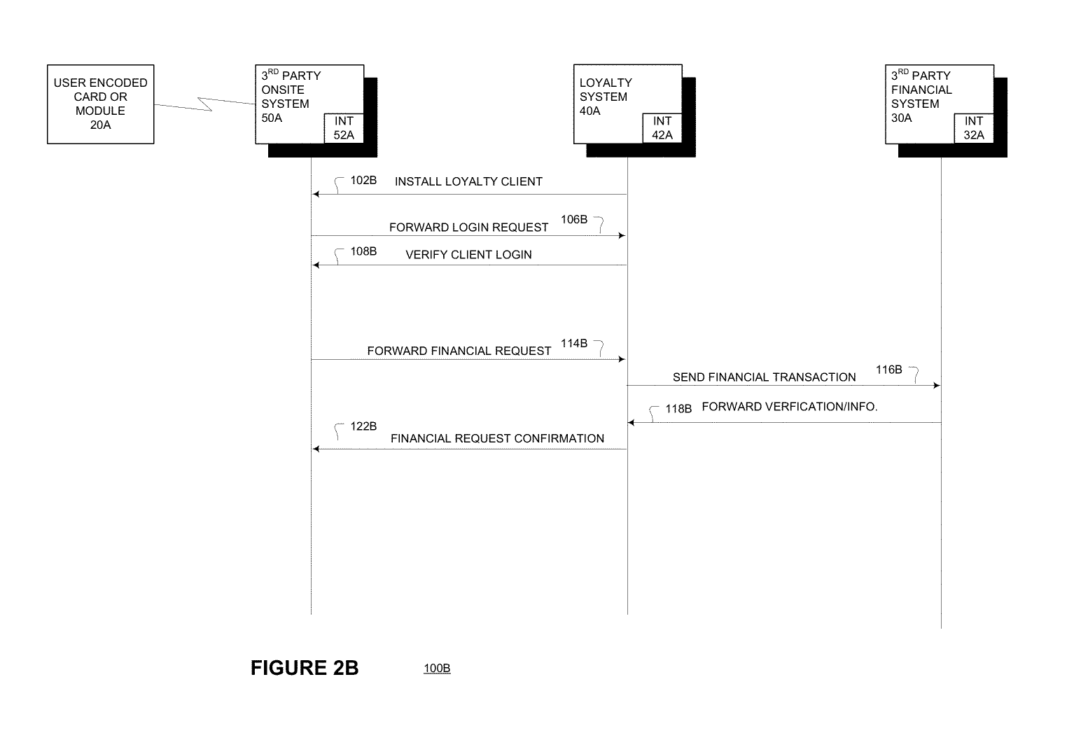

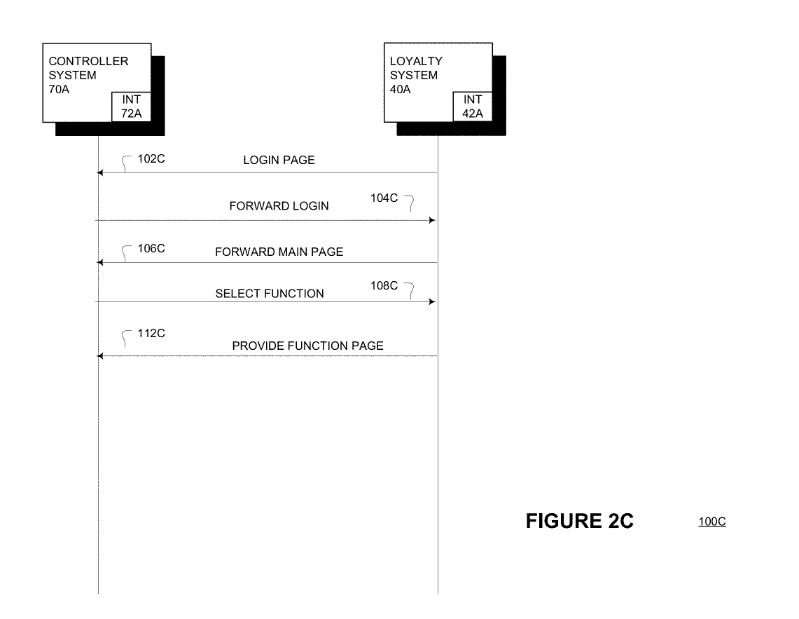

FIG. 2A is a block diagram of communications 100A between a customer or user system (CUS) 60A, goods or service provider (GSP)—3^{rd} party onsite system (GSP-OS) 50A LSI 52A, customer loyalty system (CLS) 40A, and a GSP—3^{rd} party financial system (GSP-FS) 30A. FIG. 3A is a block diagram of MP-GSP-CL architecture 10A providing a client page via HTML file 69A to a customer via a CUS 60A according to various embodiments. In an embodiment, a CUS 60A may include a web-browser application 68 that receives secure HTML files 69A including loyalty client page 69B. As also shown in FIG. 3A. a GSP-OS 50A may include the loyalty system interface client 54 that may be invoked or executed by the system module 59 and interface 52A. In an embodiment, prior to receiving the client page 69B, customer 61 may be required to log into a loyalty system via the LSI 52A of a GSP-OS 50A (communication 104A). It is noted that the LSI client 54 may be forwarded to a GSP-OS 50A to be installed its system from a loyalty system 40A (communication 102A). In another embodiment, a LSI client 54 may be installed locally on a GSP-OS 50A.

A GSP-OS 50A LSI 52A may forward login requests to a CLS 40A for verification (communications 106A, 108A). Once a customer 61 has been validated, they may be provided the client page 69B shown in FIG. 3A (communication 110A). As shown in FIG. 3A, a customer 61 via the client page 69B may be provided various functions 61 depending on their account status including checking balances of various accounts 64A, 66A, 66B, 66C. A customer may also be able to transfer funds between accounts 64B, 64C within the loyalty system where the accounts may represent other GSP or different buckets of the same GSP. Additionally, a customer may also be able to transfer funds to the loyalty system to a credit/debit card 64D and from a loyalty system to a credit/debit card 64E. When a customer 61 submits a financial transaction (communication 112A), a GSP 50A interface 52A may forward the request to a CLS 40A (communication 114A). Depending on the financial request, a CLS 40A may format and send a request for the transaction to a 3^{rd} party FS 30A (communication 116A).

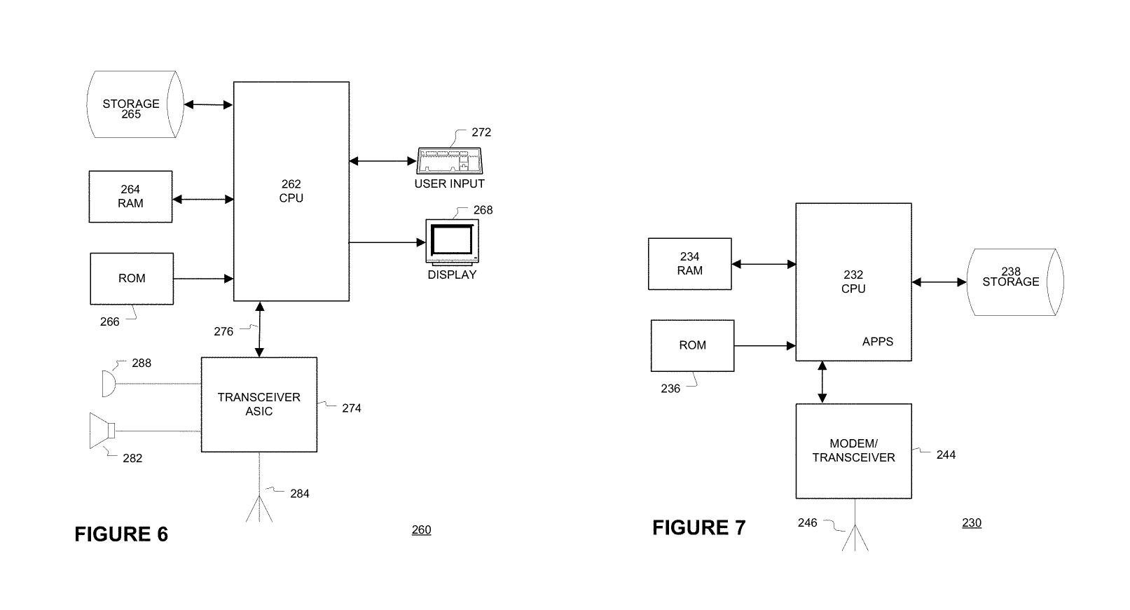

A 3^{rd} party FS 30A may forward verification and information regarding the transaction request to the CLS 40A (communication 118A). The CLS 40A may forward a transaction confirmation to the LSI 52A (communication 122A). The LSI 52A may generate an updated client page 69B based on the transaction confirmation (communication 124A). FIG. 2B is a block diagram of communications 100B between a GSP-OS 50A interface 52A, a CLS 40A, and a GSP-FS 30A where a customer 61 employs a encoded card or module UEC 20A to invoke the LSI 52A of a GSP-OS 50A. FIG. 3B is a block diagram of MP-GSP-CL 10A architecture providing a client page 69B to a customer 61 via a GSP-OS 50A display (268—FIG. 6) according to various embodiments.

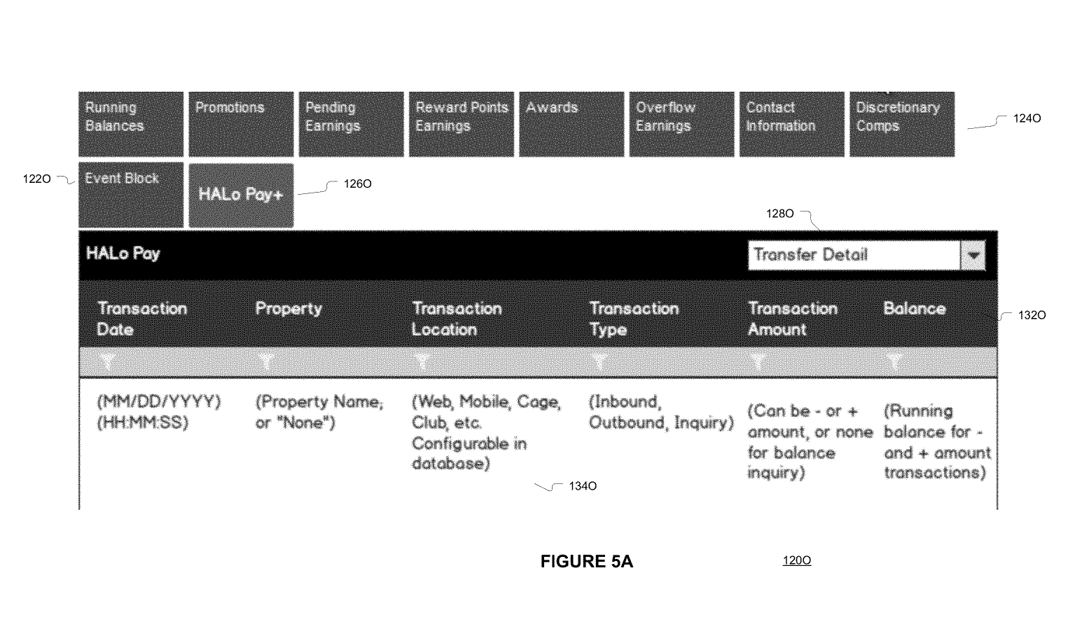

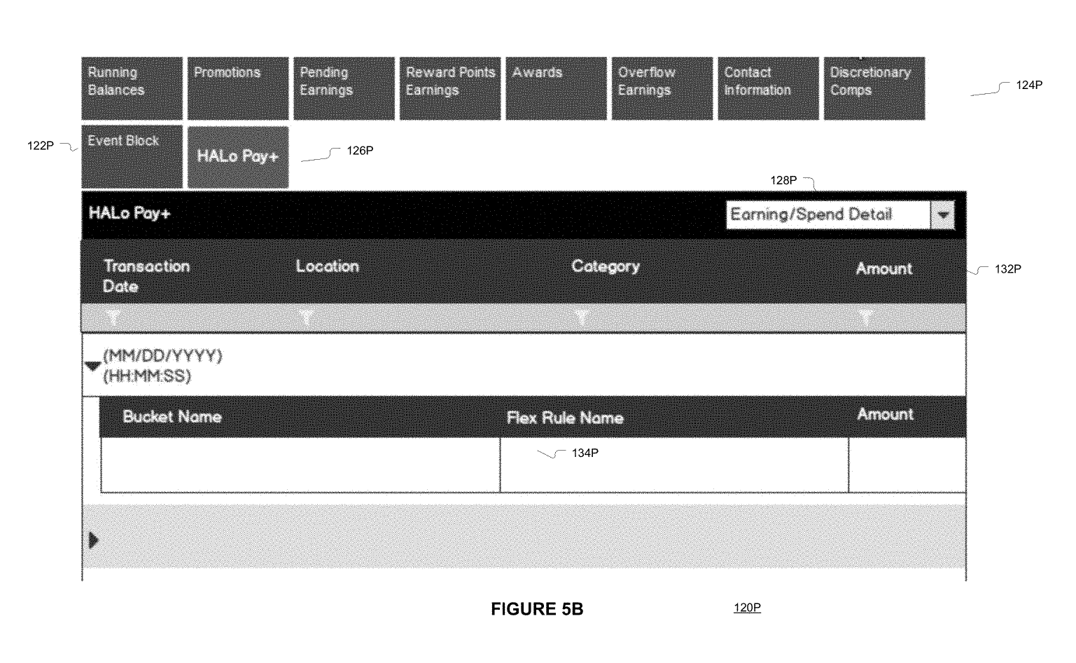

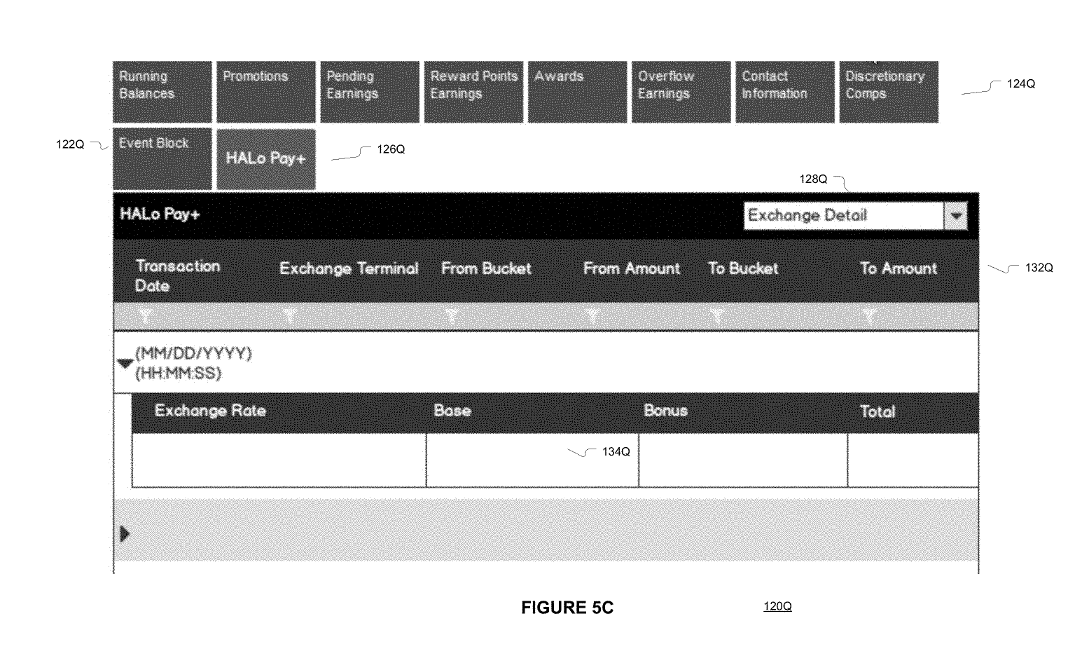

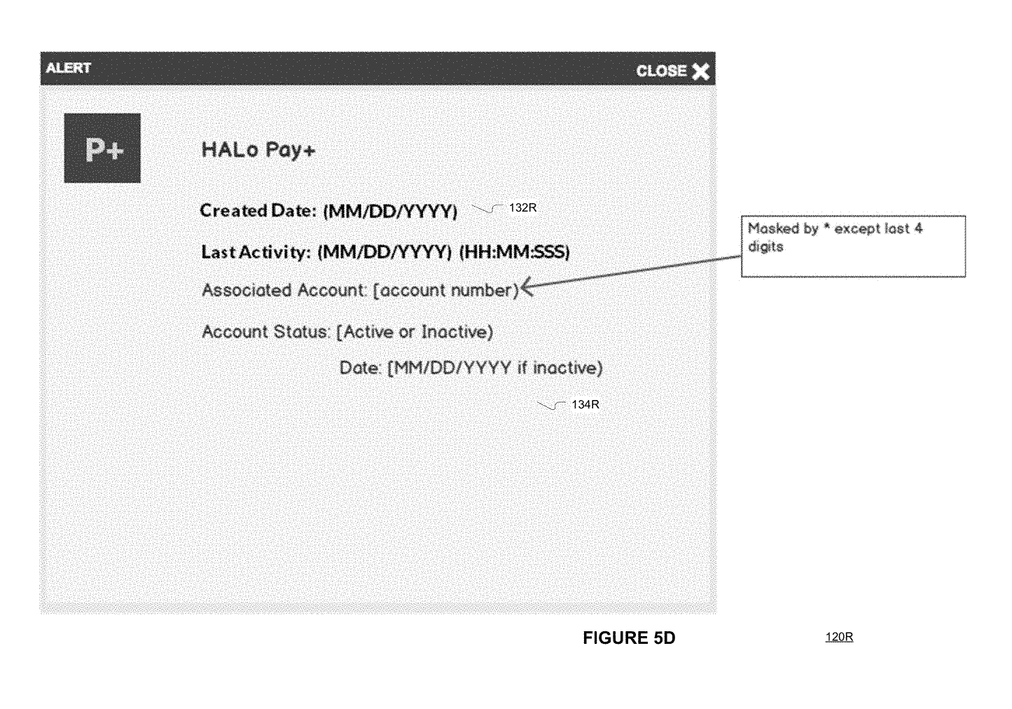

As shown in FIG. 3B, the client page 69B is similar to the client page shown on a customer or user system CUS 60A. Also similar to FIG. 3A, communications between the GSP OS 50A LSI 52A, CLS 40A, and GSP-FS 30A are similar other than the communications to a CUS 60A in FIG. 2A. In an embodiment the client page 69B may include other functions and configurations as shown in FIGS. 5A-5D. FIG. 5A illustrates a customer player dashboard or page 120O (GUI) display showing transfer details in architecture according to various embodiments. As shown in FIG. 5A, a customer page 120O shown on a CUS 60A-F or GSP-OS 50A display 268, may enable a customer to check running balances, promotions, pending earning based on activities, reward points earnings, current awards, overflow earnings, contact information for loyalty service, and discretionary compensations 124O. A customer may also select to view events 122O and look at account status via HALo Pay+ 126O, which products the HALo Pay or accounts detail page 132O. A customer 61 may select different views of account status via selection window 128O. In FIG. 5A, a customer has selected transfer detail display, which includes the transaction date, property (GSP), location, type, amount, and balance for each transaction 134D.

As shown in FIG. 5A, the transaction to an account can be inbound (points or fund into account), outbound, or status. FIG. 5B illustrates a customer-player dashboard (GUI) display 120P where a customer has selected to view earning/spending details in window 128P according to various embodiments. As shown in FIG. 5B, the earning/spending detail may include the sub-account or bucket name and flex rule name 134P.

FIG. 5C illustrates a customer-player dashboard (GUI) display 120Q where a customer has selected to view exchange details via window 128Q according to various embodiments. As shown in FIG. 5C, the exchange details 132Q includes the exchange rate, base, bonus, and total 134Q in an embodiment. FIG. 5D illustrates a customer Alert (GUI) display 120R that may displayed on a CUS 60A-F or GSP-OS 50A-H display 268 according to various embodiments. As shown in FIG. 5D, the alert display 120R may include the alert date 132R, last activity for a an account, the associated account and the account status 134R.

FIG. 2C is a block diagram of communications 100C between a CLS controller system (CLS-CS) 70A and a CLS 40A. FIG. 3C is a block diagram of MP-GSP-CL architecture 10A providing a CLS-CS main page 120A to a user or administrator via a CLS-CS 70A according to various embodiments. As shown in FIG. 2C, an administrator 61 may first login to a CLS 40A via CLS-CS 70A by completing a login page (102C, 104C). Once logged into the system 40A, the CLS 40A may provide a main page 120A via hyper-text markup language (HTML) (communications 106A) to a CLS-CS 70A.

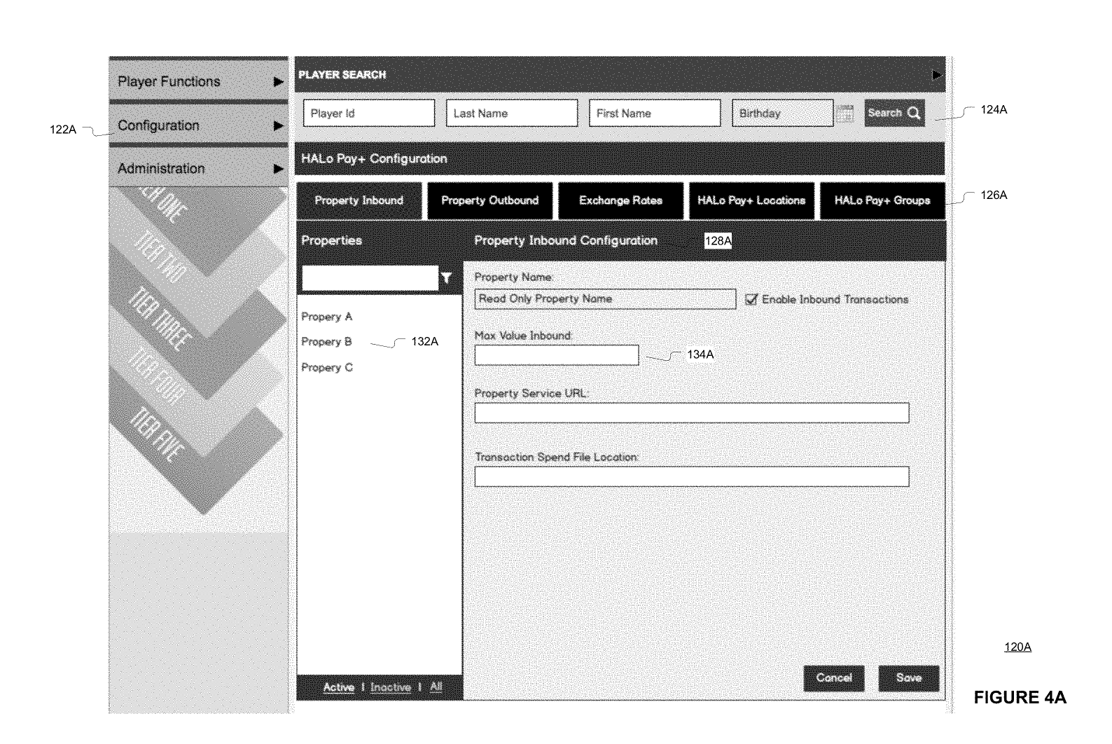

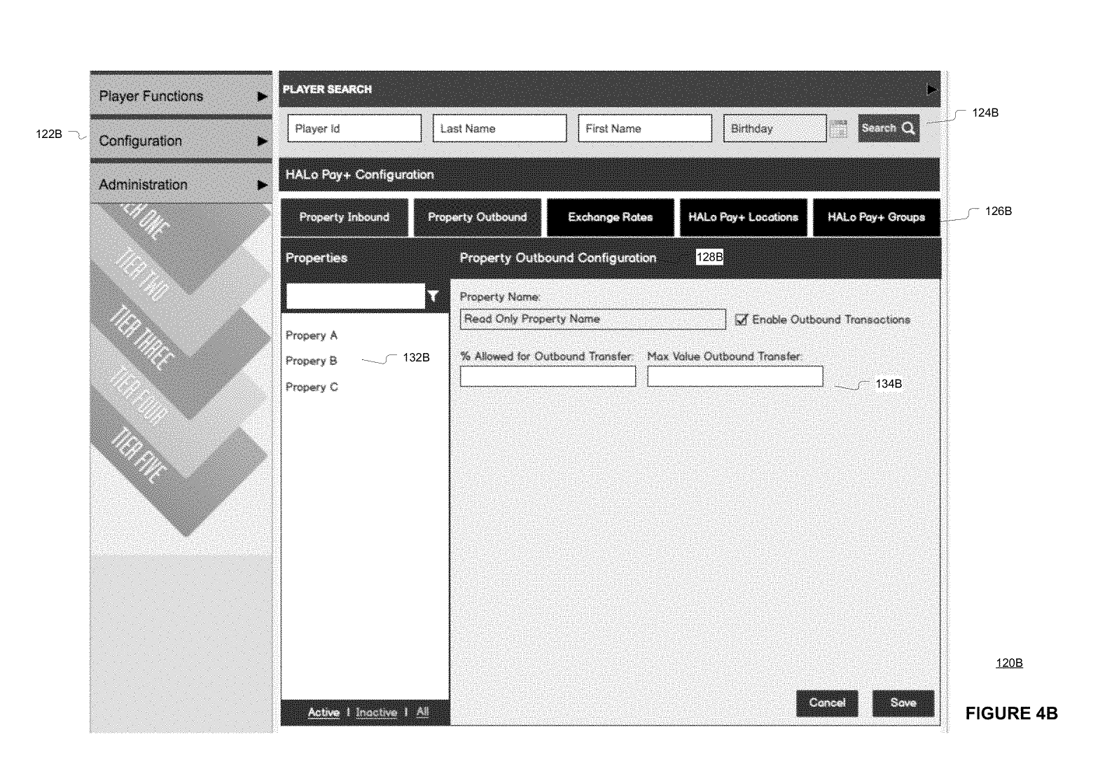

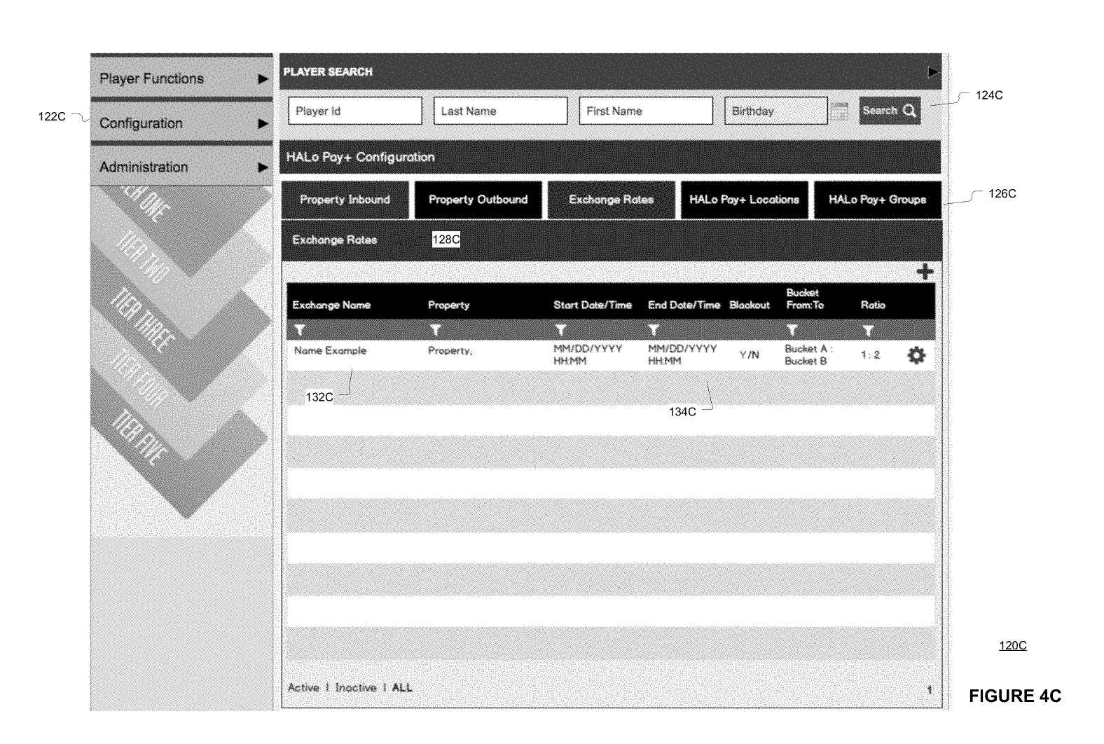

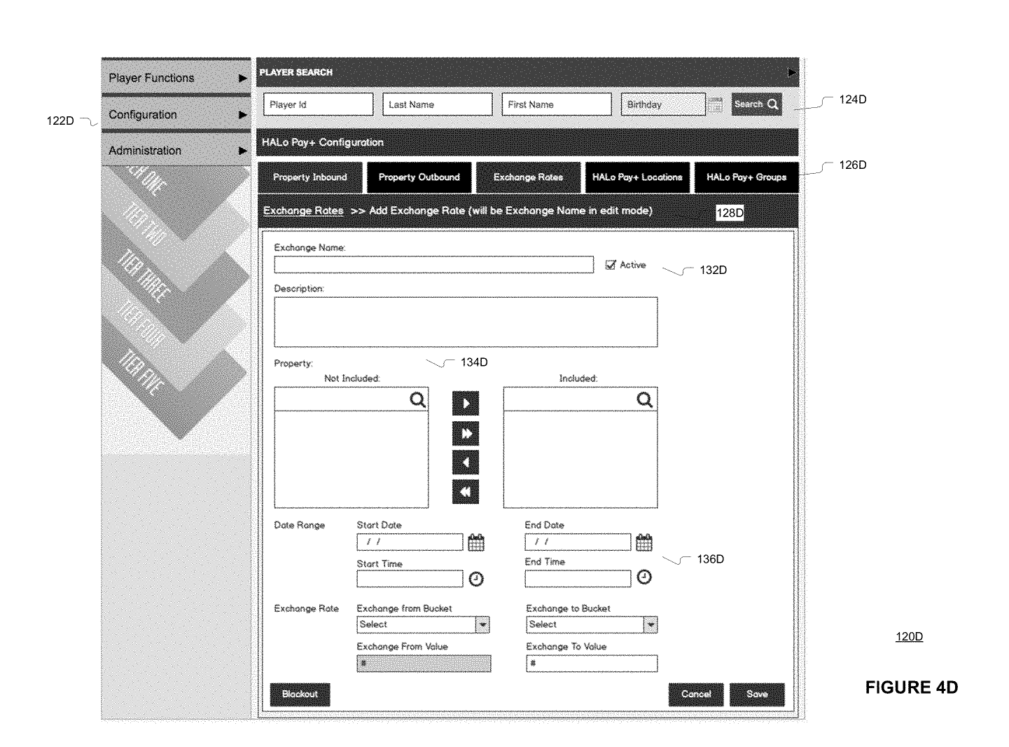

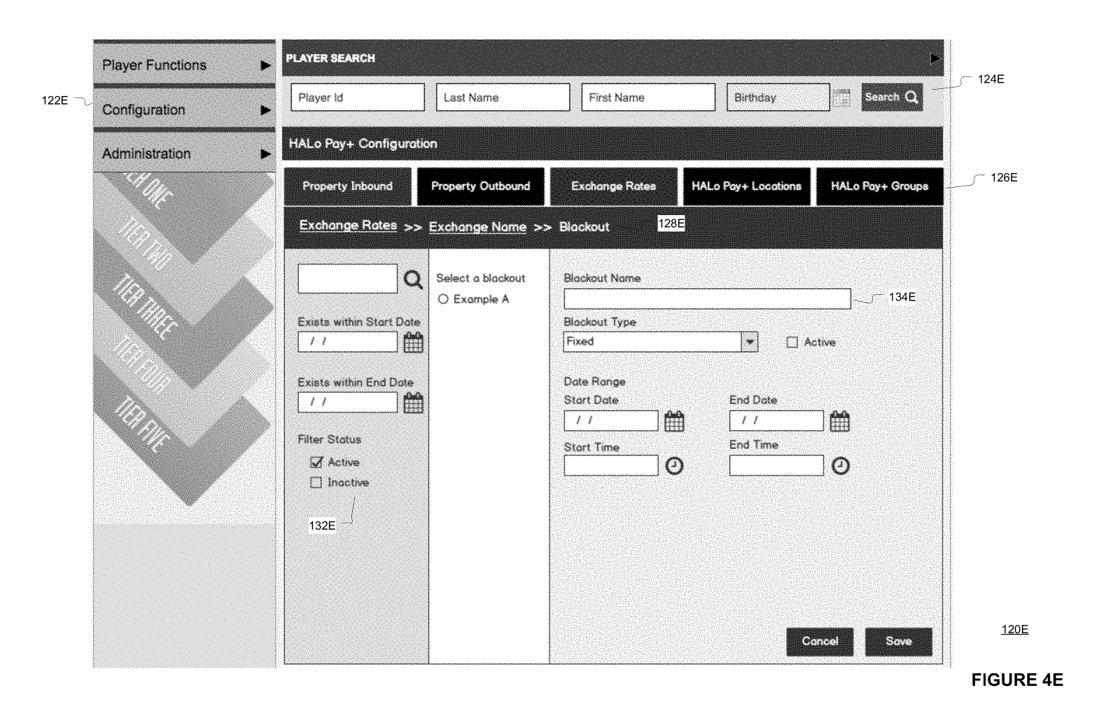

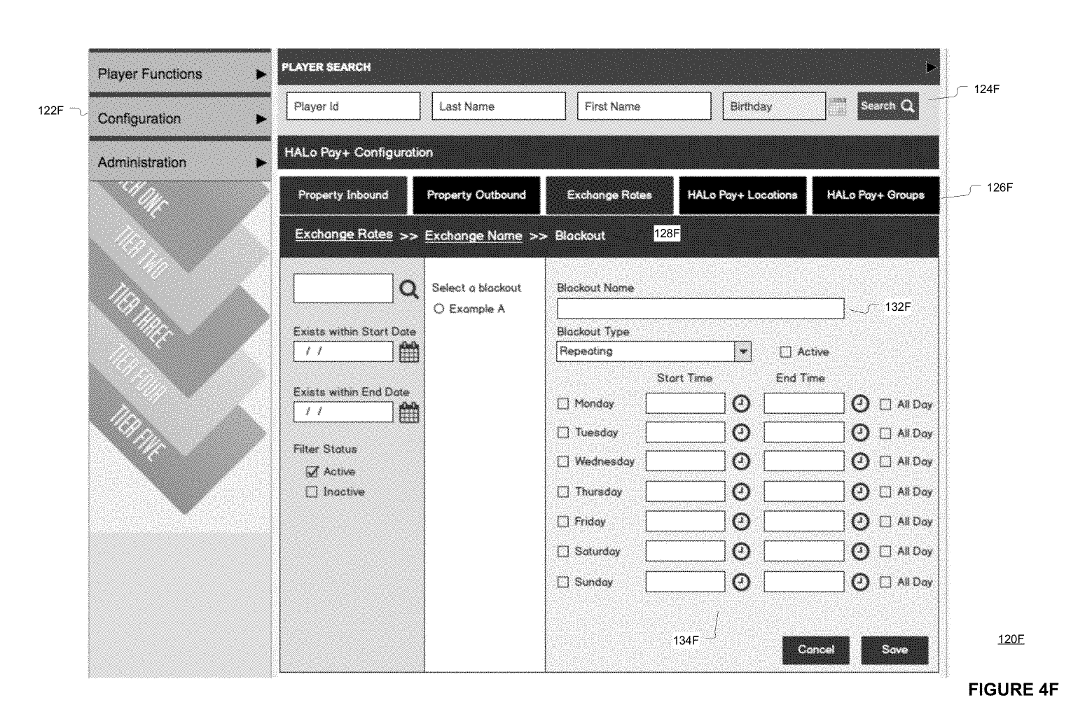

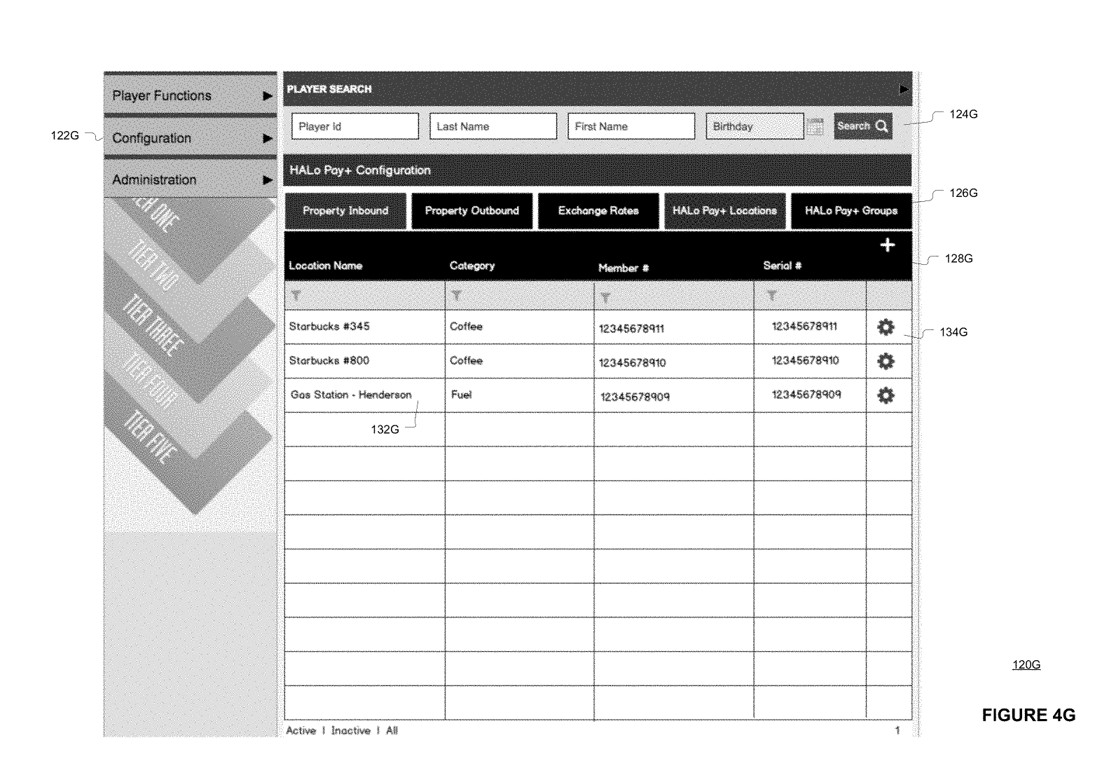

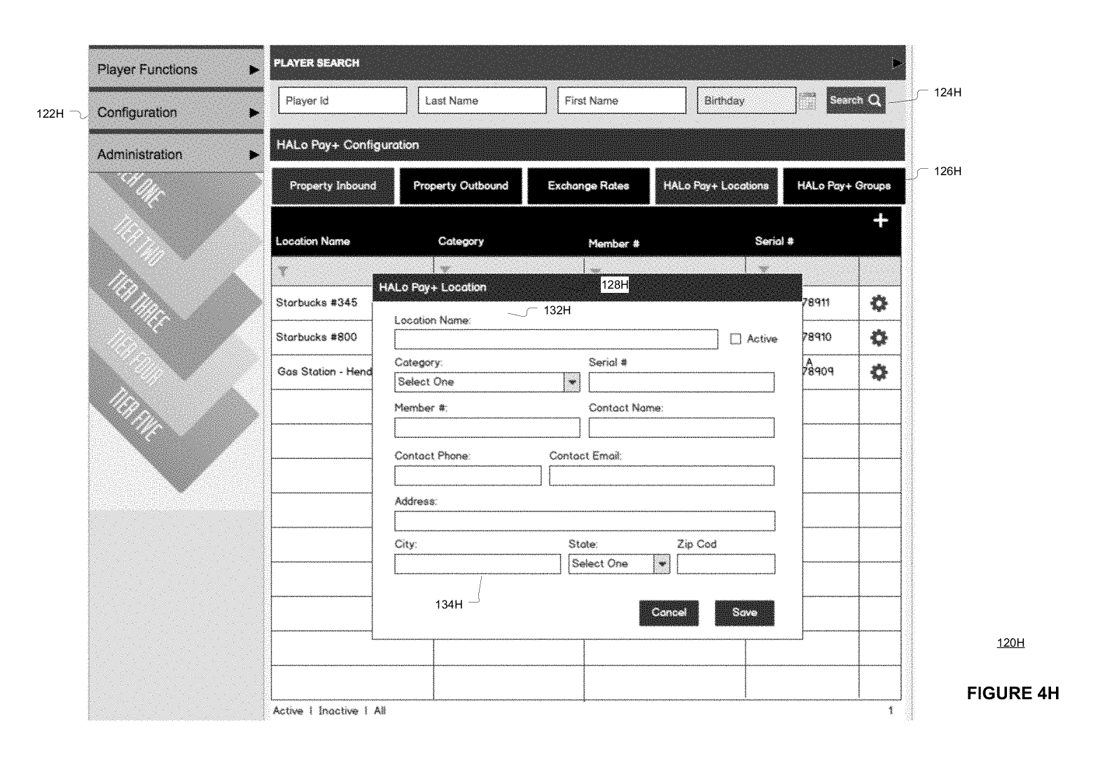

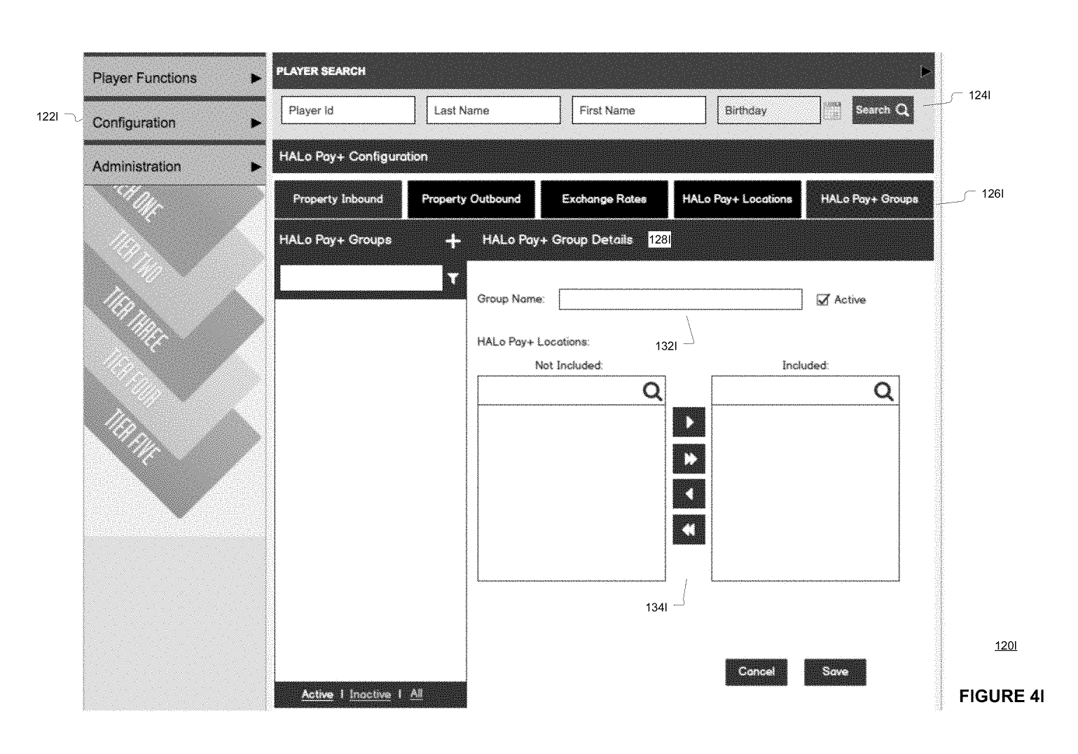

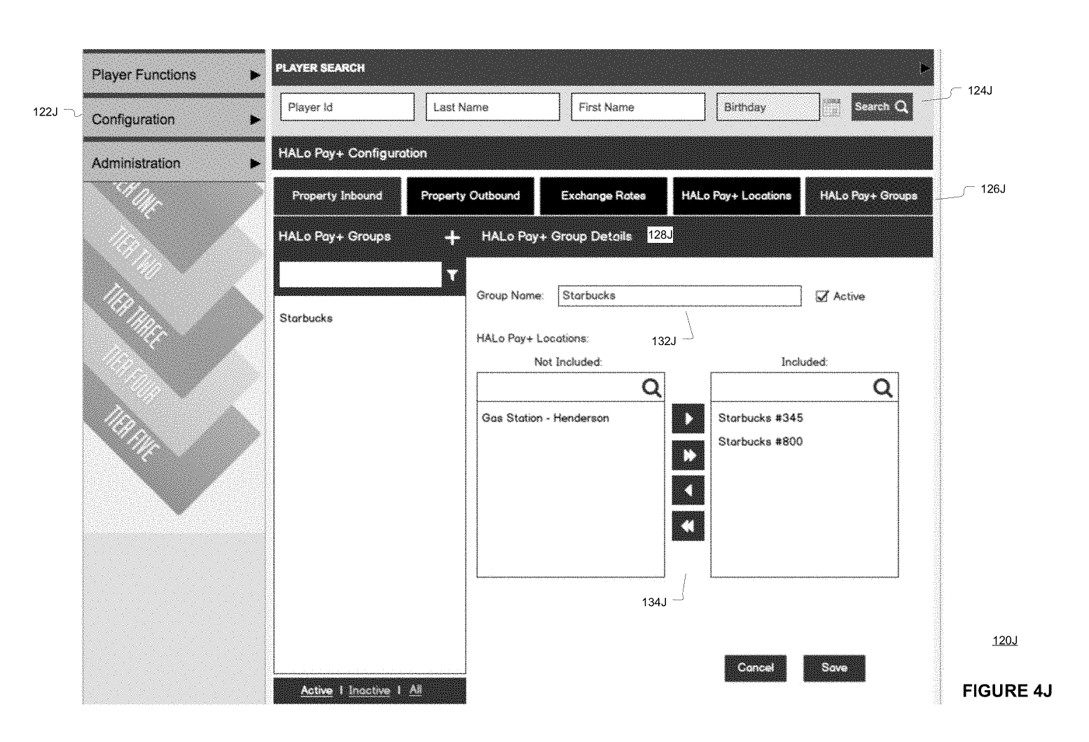

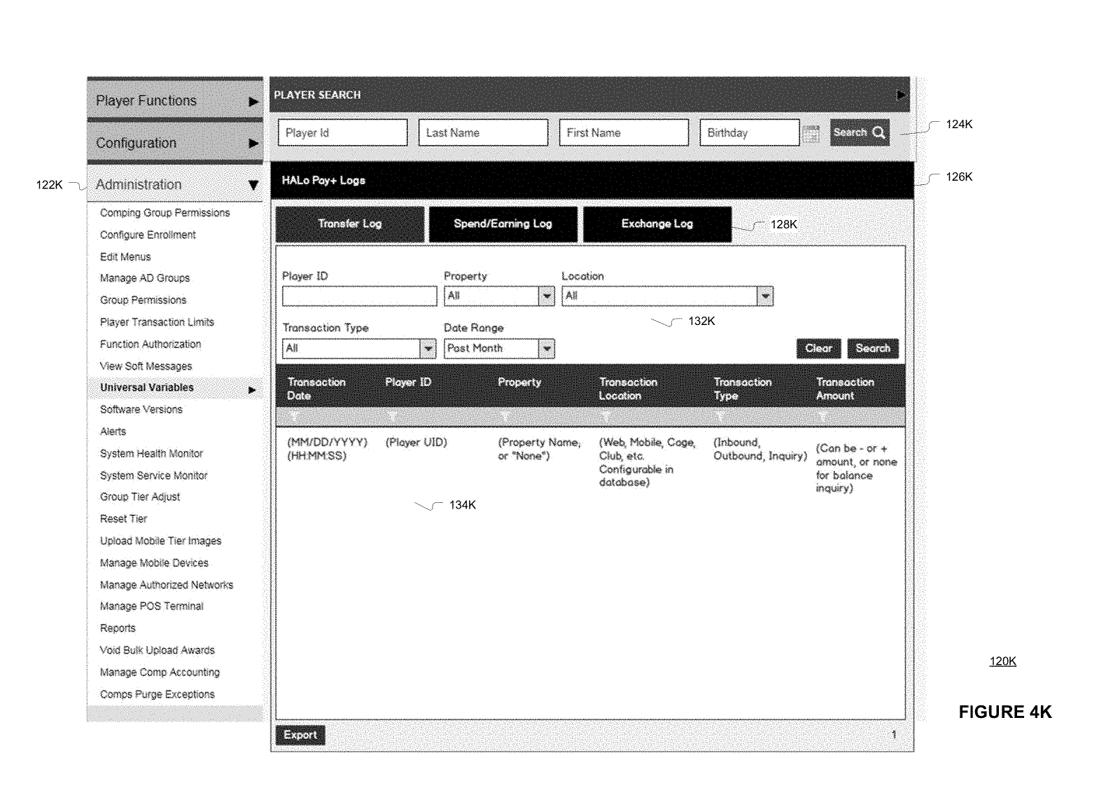

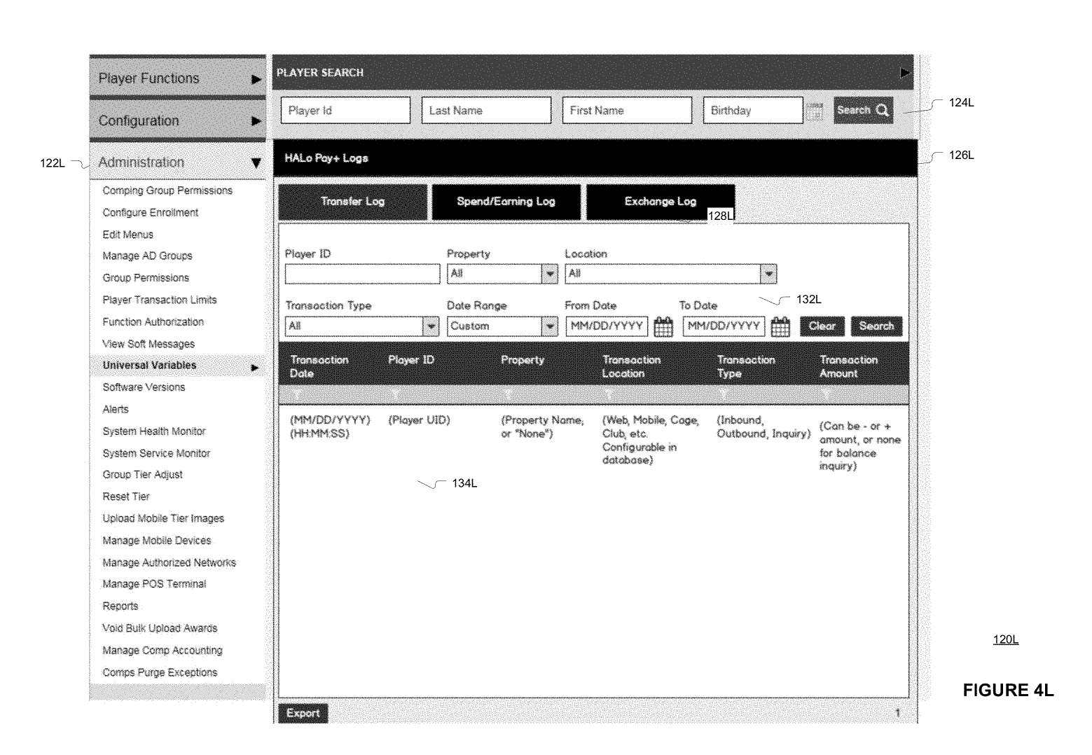

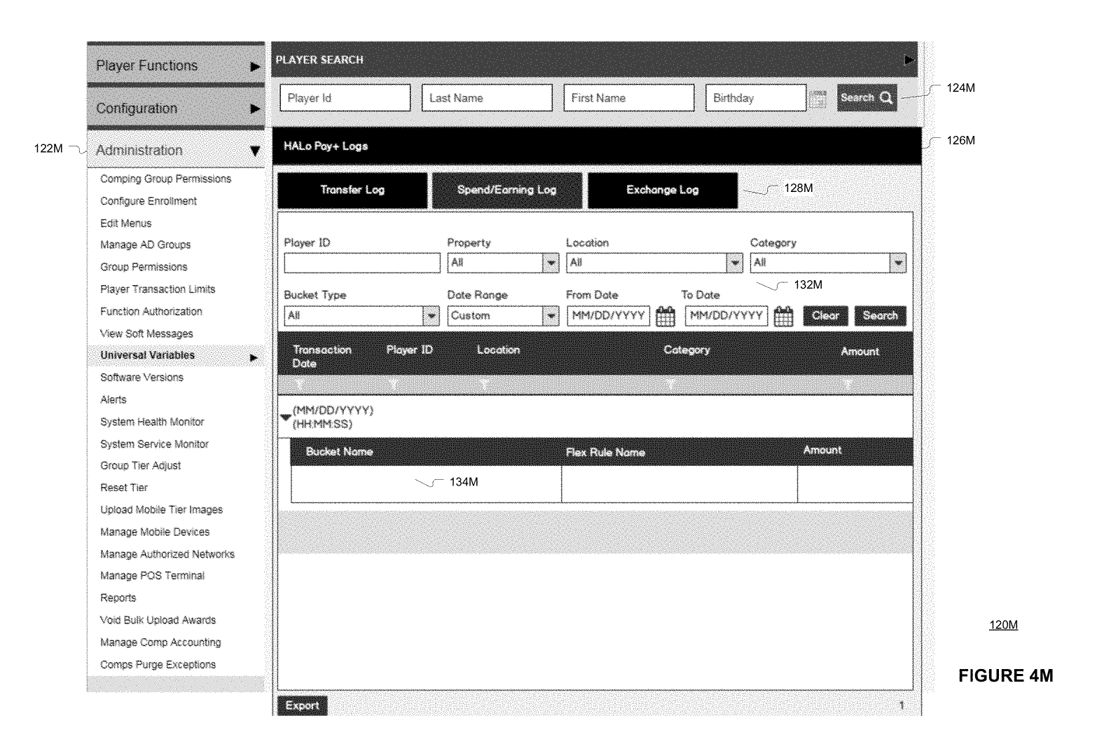

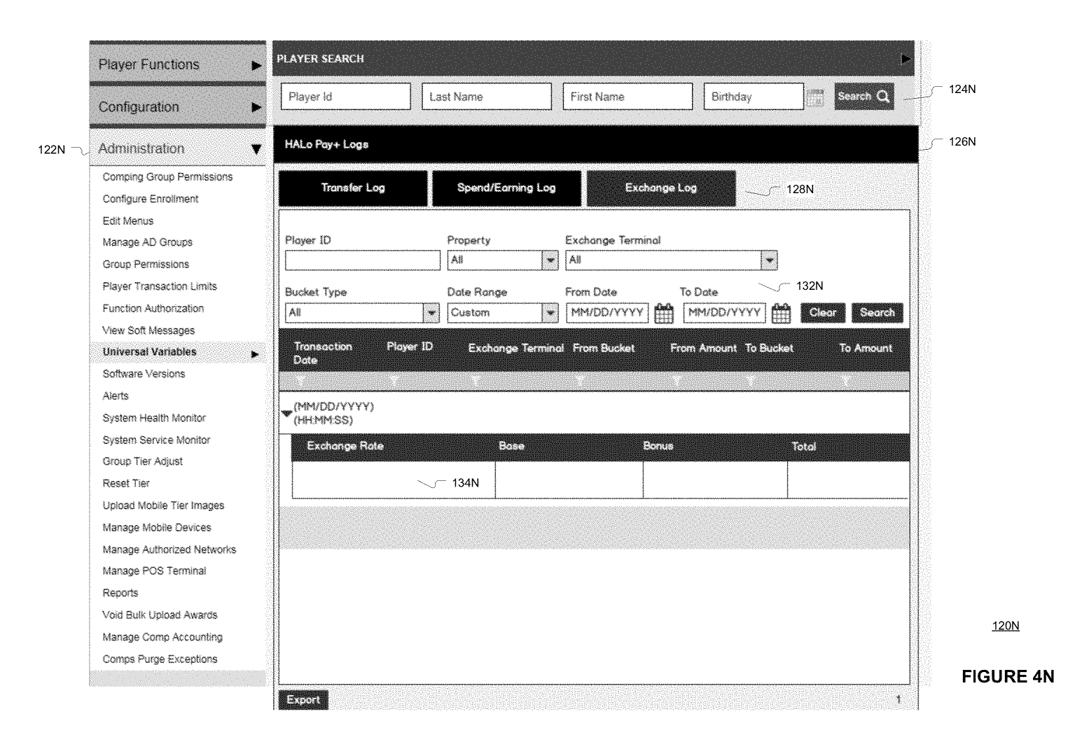

As shown in FIG. 3C and FIGS. 4A-4N, the controller system main page 120A-N includes the ability to search for players (customers) by last name, first name and date of birth 124A. An administrator 61 may also select player functions, configuration, or administration activities 122A, where the configuration activities include properties (GSPs) inbound to loyalty system, properties outbound, exchanges between properties (GSPs), locations of GSP that participate in the loyalty program, and groups of GSP that have been created or are creatable 126A. As shown in FIG. 3C, the CLS-CS 70A may include a browser application 78 to process HTML files 79 between the CSL-CS 70A and a CLS 40A. As discussed above, a CLS 40A may include an interface module 42A, master service module 48, client spending import module 43, client service module 49, database 46, and table 44 where the database 46 may include properties or participating goods and services providers, enrolled or authorized customer (or players), locations where GSP participate in the loyalty program, exchange database including exchange rate between subaccount and different GSPs in an embodiment.

As noted FIGS. 4A-4N are displays for a CLS-CS 70A-B that an administrator 61 may employ to administer a CLS 40A-B according to various embodiments. FIG. 4A illustrates a CLS-CS main page (GUI) display 120A for configuring inbound properties 128A according to various embodiments. As shown in FIG. 4A, an administrator 61 may be able to configure an inbound GSP or property name, maximum value inbound 134A, a service uniform resource locator (URL), and spend file location according to an embodiment. FIG. 4B illustrates a CLS-CS main page (GUI) display 120B for configuring outbound properties 128B according to various embodiments. As show in FIG. 4B, an administrator may be able to configure the maximum allowed value for outbound transfer 134B and percentage of transaction permitted for outbound transfer for properties 132B.

FIG. 4C illustrates a CLS-CS main page (GUI) display 120C for configuring exchange rates 126C between sub-accounts 134C of a provider according to various embodiments. As shown in FIG. 4C, an administrator may select the date range, blackout options, subaccounts (buckets), and ratio therebetween. FIG. 4D illustrates a CLS-CS main page (GUI) display 120D for adding an exchange rate for multiple properties 132D according to various embodiments. As shown in FIG. 4D, an administrator 61 may create an exchange rate or agreement between subaccounts for multiple GSPs or properties and set dates exchange is effective 136D.

FIG. 4E illustrates a CLS-CS main page (GUI) display 120E for creating blackout date range 132E for an exchange rate between accounts according to various embodiments. As shown in FIG. 4E, an administrator 61 may set an exchange rate date range 134E and name and active status 132E. FIG. 4F illustrates a CLS-CS main page (GUI) display 120F for setting blackout state weekly settings 134F for an exchange rate between accounts according to various embodiments. As shown in FIG. 4F, an administrator 61 may set an exchange rate's daily effective times 134F and name 132F.

FIG. 4G illustrates a CLS-CS main page (GUI) display 120G for viewing or configuring locations 132G for GSP or providers participating in architecture according to various embodiments. As shown in FIG. 4G, an administrator 61 may select to modify 134G or create a new location 128G in an embodiment. FIG. 4H illustrates a CLS-CS main page (GUI) display 120H for adding a location 128H for a provider participating in architecture according to various embodiments. As shown in FIG. 4H, an administrator 61 may enter details for a new location 132H, 134H.

FIG. 4I illustrates a CLS-CS main page (GUI) display 120I for setting groups of locations of providers participating in architecture according to various embodiments. As shown in FIG. 4I, an administrator 61 may select locations to be included in a group 134I and set the group name 132I where FIG. 4J shows an example where two Starbucks locations 134J have been added to a group named Starbucks 132J.

FIG. 4K illustrates a CLS-CS main administrative page (GUI) display 120K for viewing logs of transfers 134K for past month in architecture according to various embodiments. FIG. 4L illustrates a CLS-CS main page (GUI) display 120L for viewing logs of transfers for a custom date range 132L in architecture according to various embodiments. As shown in FIGS. 4K and 4L, the transfer log includes the transfer date, customer or player ID, property (GSP), location, type, and amount. Similarly, FIG. 4M illustrates a CLS-CS main page (GUI) display 120M for viewing spend/earning logs 134M for a custom date range 132M in architecture according to various embodiments and FIG. 4N illustrates a CLS-CS main page (GUI) display 120N for viewing exchange logs 134N for a custom date range for past month in architecture according to various embodiments.

In an embodiment the networks 16A, 16B may represent several networks and support many wire or wireless protocols and enable communication in architectures 10A-B using one or more known digital communication formats including a cellular protocol such as code division multiple access (CDMA), time division multiple access (TDMA), Global System for Mobile Communications (GSM), cellular digital packet data (CDPD), Worldwide Interoperability for Microwave Access (WiMAX), satellite format (COMSAT) format, and local protocol such as wireless local area network (commonly called “WiFi”), Near Field Communication (NFC), radio frequency identifier (RFID), ZigBee (IEEE 802.15 standard) (and Bluetooth).

As known to one skilled on the art the Bluetooth protocol includes several versions including v1.0, v1.0B, v1.1, v1.2, v2.0+EDR, v2.1+EDR, v3.0+HS, and v4.0. The Bluetooth protocol is an efficient packet-based protocol that may employ frequency-hopping spread spectrum radio communication signals with up to 79 bands, each band 1 MHz in width, the respective 79 bands operating in the frequency range 2402-2480 MHz. Non-EDR (extended data rate) Bluetooth protocols may employ a Gaussian frequency-shift keying (GFSK) modulation. EDR Bluetooth may employ a differential quadrature phase-shift keying (DQPSK) modulation.

The WiFi protocol may conform to an Institute of Electrical and Electronics Engineers (IEEE) 802.11 protocol. The IEEE 802.11 protocols may employ a single-carrier direct-sequence spread spectrum radio technology and a multi-carrier orthogonal frequency-division multiplexing (OFDM) protocol. In an embodiment, one or more devices 30A-F, implementation controllers 40A, 40B, and hardware implementations 20A-D may communicate in in architecture 10A-D and 50A-50C via a WiFi protocol.

The cellular formats CDMA, TDMA, GSM, CDPD, and WiMax are well known to one skilled in the art. It is noted that the WiMax protocol may be used for local communication between the one or more GSP-FS 30A-B, CLS 40A-B, GSP-OS 50A-H, CUS 60A-F, and CLS-CS 70A-B. The WiMax protocol is part of an evolving family of standards being developed by the Institute of Electrical and Electronic Engineers (IEEE) to define parameters of a point-to-multipoint wireless, packet-switched communications systems. In particular, the 802.16 family of standards (e.g., the IEEE std. 802.16-2004 (published Sep. 18, 2004)) may provide for fixed, portable, and/or mobile broadband wireless access networks. Additional information regarding the IEEE 802.16 standard may be found in IEEE Standard for Local and Metropolitan Area Networks—Part 16: Air Interface for Fixed Broadband Wireless Access Systems (published Oct. 1, 2004). See also IEEE 802.16E-2005, IEEE Standard for Local and Metropolitan Area Networks—Part 16: Air Interface for Fixed and Mobile Broadband Wireless Access Systems—Amendment for Physical and Medium Access Control Layers for Combined Fixed and Mobile Operation in Licensed Bands (published Feb. 28, 2006). Further, the Worldwide Interoperability for Microwave Access (WiMAX) Forum facilitates the deployment of broadband wireless networks based on the IEEE 802.16 standards. For convenience, the terms “802.16” and “WiMAX” may be used interchangeably throughout this disclosure to refer to the IEEE 802.16 suite of air interface standards. The ZigBee protocol may conform to the IEEE 802.15 network and two or more devices 30A-F may form a mesh network.

A device 260 is shown in FIG. 6 that may be used in various embodiments as CUS 60A-F, GSP-OS 50A-H, and CLS-CS 70A-B. The device 260 may include a central processing unit (CPU) 262, a random access memory (RAM) 264, a read only memory (ROM) 266, a display 268, a user input device 272, a transceiver application specific integrated circuit (ASIC) 274, a microphone 288, a speaker 282, a storage unit 265, and an antenna 284. The CPU 262 may include an application module 292 including a browser application module.

The storage device 265 may comprise any convenient form of data storage and may be used to store temporary program information, queues, databases, and overhead information. The ROM 266 may be coupled to the CPU 262 and may store the program instructions to be executed by the CPU 262, and the application module 292. The RAM 264 may be coupled to the CPU 262 and may store temporary program data, and overhead information. The user input device 272 may comprise an input device such as a keypad, touch screen, track ball or other similar input device that allows the user to navigate through menus, displays in order to operate the device 260. The display 268 may be an output device such as a CRT, LCD, touch screen, or other similar screen display that enables the user to read, view, or hear received messages, displays, or pages.

A microphone 288 and a speaker 282 may be incorporated into the device 260. The microphone 288 and speaker 282 may also be separated from the device 260. Received data may be transmitted to the CPU 262 via a bus 276 where the data may include messages, displays, or pages received, messages, displays, or pages to be transmitted, or protocol information. The transceiver ASIC 274 may include an instruction set necessary to communicate messages, displays, or pages in architectures 10A-B. The ASIC 274 may be coupled to the antenna 284 to communicate wireless messages, displays, or pages within the architectures 10A-B. When a message is received by the transceiver ASIC 274, its corresponding data may be transferred to the CPU 262 via the bus 276. The data can include wireless protocol, overhead information, and pages and displays to be processed by the device 260 in accordance with the methods described herein.

FIG. 7 illustrates a block diagram of a device 230 that may be employed as a GSP-FS 30A-B or CLS 40A-B in various embodiments. The device 230 may include a CPU 232, a RAM 234, a ROM 236, a storage unit 238, a modem/transceiver 244, and an antenna 246. The CPU 232 may include a web-server 254 and application module 252.

The modem/transceiver 244 may couple, in a well-known manner, the device 230 to the network 16A, 16B to enable communication with a GSP-FS 30A-B, CLS 40A-B, GSP-OS 50A-H, CUS 60A-F, and CLS-CS 70A-B. In an embodiment, the modem/transceiver 244 may be a wireless modem or other communication device that may enable communication with a GSP-FS 30A-B, CLS 40A-B, GSP-OS 50A-H, CUS 60A-F, and CLS-CS 70A-B.

The ROM 236 may store program instructions to be executed by the CPU 232. The RAM 234 may be used to store temporary program information, queues, databases, and overhead information. The storage device 238 may comprise any convenient form of data storage and may be used to store temporary program information, queues, databases, and overhead information.

Any of the components previously described can be implemented in a number of ways, including embodiments in software. Any of the components previously described can be implemented in a number of ways, including embodiments in software. Thus, the CPU 232, modem/transceiver 244, antenna 246, storage 238, RAM 234, ROM 236, CPU 262, transceiver ASIC 274, antenna 284, microphone 288, speaker 282, ROM 266, RAM 264, user input 272, display 268, GSP-FS 30A-B, CLS 40A-B, GSP-OS 50A-H, CUS 60A-F, and CLS-CS 70A-B may all be characterized as “modules” herein.

The modules may include hardware circuitry, single or multi-processor circuits, memory circuits, software program modules and objects, firmware, and combinations thereof, as desired by the architect of the architecture 10 and as appropriate for particular implementations of various embodiments.

The apparatus and systems of various embodiments may be useful in applications other than a sales architecture configuration. They are not intended to serve as a complete description of all the elements and features of apparatus and systems that might make use of the structures described herein.

Applications that may include the novel apparatus and systems of various embodiments include electronic circuitry used in high-speed computers, communication and signal processing circuitry, modems, single or multi-processor modules, single or multiple embedded processors, data switches, and application-specific modules, including multilayer, multi-chip modules. Such apparatus and systems may further be included as sub-components within a variety of electronic systems, such as televisions, cellular telephones, personal computers (e.g., laptop computers, desktop computers, handheld computers, tablet computers, etc.), workstations, radios, video players, audio players (e.g., mp3 players), vehicles, medical devices (e.g., heart monitor, blood pressure monitor, etc.) and others. Some embodiments may include a number of methods.

It may be possible to execute the activities described herein in an order other than the order described. Various activities described with respect to the methods identified herein can be executed in repetitive, serial, or parallel fashion.

A software program may be launched from a computer-readable medium in a computer-based system to execute functions defined in the software program. Various programming languages may be employed to create software programs designed to implement and perform the methods disclosed herein. The programs may be structured in an object-orientated format using an object-oriented language such as Java or C++. Alternatively, the programs may be structured in a procedure-orientated format using a procedural language, such as assembly or C. The software components may communicate using a number of mechanisms well known to those skilled in the art, such as application program interfaces or inter-process communication techniques, including remote procedure calls. The teachings of various embodiments are not limited to any particular programming language or environment.

The accompanying drawings that form a part hereof show, by way of illustration and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein individually or collectively by the term “invention” merely for convenience and without intending to voluntarily limit the scope of this application to any single invention or inventive concept, if more than one is in fact disclosed. Thus, although specific embodiments have been illustrated and described herein, any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. § 1.72(b), requiring an abstract that will allow the reader to quickly ascertain the nature of the technical disclosure. It is submitted with the understanding that it will not be used to interpret or limit the scope or meaning of the claims. In the foregoing Detailed Description, various features are grouped together in a single embodiment for the purpose of streamlining the disclosure. This method of disclosure is not to be interpreted to require more features than are expressly recited in each claim. Rather, inventive subject matter may be found in less than all features of a single disclosed embodiment. Thus the following claims are hereby incorporated into the Detailed Description, with each claim standing on its own as a separate embodiment.

1. A customer loyalty architecture, comprising:
a customer loyalty system including a database of goods and service providers participating in a loyalty program, a database of customers enrolled in the royalty program, and a location database including locations where the goods and service providers participate in the loyalty program;
a goods and service provider onsite system including a loyalty system interface configured to provide a customer loyalty menu to a customer via one of a customer electronic device wirelessly and a display of the goods and service provider onsite system; and
a customer loyalty control system for configuring the operation of the customer loyalty system including the database of goods and service providers participating in a loyalty program, the database of customers enrolled in the royalty program, and the location database including locations where the goods and service providers participate in the loyalty program.

2. The customer loyalty architecture of claim 1, further comprising a plurality of goods and service provider onsite systems including a loyalty system interface configured to provide a customer loyalty menu to a customer via one of a customer electronic device wirelessly and a display of the goods and service provider onsite system.

3. The customer loyalty architecture of claim 1, further comprising a plurality of goods and service provider onsite systems at a single facility, each goods and service provider onsite system including a loyalty system interface configured to provide a customer loyalty menu to a customer via one of a customer electronic device wirelessly and a display of the goods and service provider onsite system.

4. The customer loyalty architecture of claim 1, wherein the goods and service provider onsite system is an electronic gaming system and the loyalty system interface operates as part of the system functions.

5. The customer loyalty architecture of claim 1, further comprising a financial system, the customer loyalty system forwarding financial transaction requests from the goods and service provider onsite system to the financial system for processing.

6. The customer loyalty architecture of claim 5, wherein the financial system is independently controlled.

7. The customer loyalty architecture of claim 4, further comprising a financial system, the customer loyalty system forwarding financial transaction requests from the goods and service provider onsite system to the financial system for processing.

8. The customer loyalty architecture of claim 7, wherein the financial system is independently controlled.

9. The customer loyalty architecture of claim 1, wherein the customer loyalty system provides the loyalty system interface to the goods and service provider onsite system.

10. The customer loyalty architecture of claim 1, wherein the customer loyalty system includes an interface that provides the loyalty system interface to the goods and service provider onsite system.

11. A customer loyalty system, comprising:
a database of goods and service providers participating in a loyalty program;
a database of customers enrolled in the royalty program;
a location database including locations where the goods and service providers participate in the loyalty program; and
an interface communicating with a goods and service provider onsite system including a loyalty system interface configured to provide a customer loyalty menu to a customer via one of a customer electronic device wirelessly and a display of the goods and service provider onsite system and communicating with a customer loyalty control system for configuring the operation of the customer loyalty system including the database of goods and service providers participating in a loyalty program, the database of customers enrolled in the royalty program, and the location database including locations where the goods and service providers participate in the loyalty program.

12. The customer loyalty system of claim 11, wherein the interface provides the loyalty system interface to the goods and service provider onsite system.

13. The customer loyalty system of claim 11, wherein the interface communicates with a plurality of goods and service provider onsite systems including a loyalty system interface configured to provide a customer loyalty menu to a customer via one of a customer electronic device wirelessly and a display of the goods and service provider onsite system.

14. The customer loyalty system of claim 11, wherein the interface communicates with a plurality of goods and service provider onsite systems at a single facility, each goods and service provider onsite system including a loyalty system interface configured to provide a customer loyalty menu to a customer via one of a customer electronic device wirelessly and a display of the goods and service provider onsite system.

15. The customer loyalty system of claim 11, wherein the goods and service provider onsite system is an electronic gaming system and the loyalty system interface operates as part of the system functions.

16. The customer loyalty system of claim 11, wherein the interface provides the loyalty system interface to the goods and service provider onsite system.

17. The customer loyalty system of claim 11, wherein the interface further communicates with a financial system, the customer loyalty system interface forwarding financial transaction requests received from the goods and service provider onsite system to the financial system for processing.

18. The customer loyalty architecture of claim 17, wherein the financial system is independently controlled.

19. The customer loyalty architecture of claim 15, wherein the interface further communicates with a financial system, the customer loyalty system interface forwarding financial transaction requests received from the goods and service provider onsite system to the financial system for processing.

20. The customer loyalty architecture of claim 19, wherein the financial system is independently controlled.
